(19) United States
(12) Patent Application Publication
(10) Pub. No.: US 2008/0313367 A1
(43) Pub. Date: Dec. 18, 2008

(54) REPRODUCING DEVICE OF INFORMATION STORAGE MEDIUM REPRODUCING METHOD THEREOF

(75) Inventors: Daisuke Machiya, Fussa-shi (JP); Kouji Saito, Akishima-shi (JP); Akinori Tokunaga, Kokubunji-shi (JP); Takero Kobayashi, Akishima-shi (JP); Masaya Kato, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/105,742

(22) Filed: Apr. 18, 2008

(30) Foreign Application Priority Data
Jun. 14, 2007 (JP) 2007-156989

(51) Int. Cl. G06F 3/00

(52) U.S. Cl. 710/52

(57) ABSTRACT

According to one embodiment, a reproducing device of an information storage medium sufficiently reproduces resource data of advanced contents as much as possible. The device uses a ring buffer to temporarily store packets of resource data of a video stream. Packets read out from the buffer are basically transferred to a file cache in response to a playlist. If a storage area in the cache cannot be secured, a packet list storage unit stores a packet list to be stored in the buffer. The packet list includes a pointer on the buffer of packets composing the resource data. When the cache makes it possible to store the packets therein, the buffer can transfer the packets to the cache at a high speed.

### CROSS-REFERENCE TO RELATED APPLICATIONS

This application is based upon and claims the benefit of priority from Japanese Patent Application No. 2007-156989, filed Jun. 14, 2007, the entire contents of which are incorporated herein by reference.

### BACKGROUND

1. Field

One embodiment of the invention relates to a reproducing device of an information storage medium and reproducing method thereof which are effective, for example, as a reproducing device and a reproducing method of advanced contents of a high definition or high density (HD) digital versatile disc (DVD).

2. Description of the Related Art

In a DVD player, a method for storing a data stream which has been read out from a DVD into a ring buffer, and for transferring data which has been read out from the ring buffer to a decoder has been used (e.g., Jpn. Pat. Appln KOKAI Publication No. 2003-59189). This ring buffer has been used for compensating a difference between a time necessary for reading out the data and a time necessary for decoding in the decoder.

Recently, the HD DVD has been developed, the HD DVD has been diversified in comparison with a conventional DVD, and the HD DVD has made it possible to arrange a variety of contents before decoding as resource data on a time line in response to a playlist to reproduce the contents. As for a buffer to arrange the contents before decoding on the time line, a file cache is used. The contents before decoding on the time line are transmitted sequentially to the decoder.

Here, it is contrived for the HD DVD so as to reproduce a primary video, a secondary video, advanced contents, etc., as the resource data.

There is resource data, such as, a PNG image file and a WAV voice file to be processed by a menu display application in reproducing the advanced contents. The WAV voice file is, for example, the resource data to be processed by a video commentary application. This invention aims at items of resource data which is processed through the menu display application.

The data which is read out from the HD DVD is applied with error-correction processing and decoded, then guided to a packet separation unit as a pack list. The kinds packs to be separated by the packet separation unit include a navigation pack (NV PCK), a main video pack (VM PCK), a sub video pack (VS PCK), a main audio pack (AM PCK), a sub audio pack (AS PCK), a sub picture pack (SP PCK), advanced contents packet (ADV PCK), etc.

In the case in which the advanced contents include moving picture/voice data and resource data to be multiplexed on the moving picture/voice data, it is necessary to absorb a time lag between a processing time of an application processing unit based on time information of the moving picture/voice data and a processing time of a packet separation processing unit of the resource data. It is not until the time lag is appropriately absorbed that appropriate reproduction output timing of the advanced contents is achieved.

However, the HD DVD standard does not define anything with respect to the time lag between the timing at which an advanced pack is separated and the timing at which an advanced application starts processing for the resource data. This results from the fact that the timing depends on a capacity and a processing speed of hardware. As a result, some players cannot sufficiently reproduce the resource data of advanced contents which has been created by a provider.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred configuration view showing a form of implementation of an HD DVD player with the present invention applied thereto;

FIG. 2 shows an example of processing timing of resource data to be processed by a device of an embodiment of the invention;

FIG. 3 is a preferred flowchart showing operations of a packet separation processing unit of FIG. 1;

FIG. 4A is a preferred explanation view which is shown for explaining operations of a ring buffer of FIG. 1;

FIG. 4B shows an example of a packet list storage unit of FIG. 1;

FIG. 5 shows an example of a packet to be stored in a file cache of FIG. 1; and

FIG. 6 is a flowchart showing for explaining an example of overall operation of a device in FIG. 1.

### DETAILED DESCRIPTION

Various embodiments according to the invention will be described hereinafter with reference to the accompanying drawings.

An example of the invention provides a reproducing device of an information storage medium and which is configured to reproduce resource data of advanced contents as sufficient as possible and a reproducing method of the information storage medium.

To solve the aforementioned problem, the reproducing device basically includes a data acquisition means for acquiring prescribed unit data, and a ring buffer which temporarily stores the prescribed unit data from the acquisition means. The reproducing device also includes a memory means for storing the prescribed unit data from the ring buffer in response to an application. The device further includes a first processing unit and a second processing unit.

The first processing unit stores the application which processes the prescribed unit data to be stored in the memory means, and stores an identification list which shows the presence or absence of a relationship between the application and the prescribed unit data.

The second processing unit includes a read pointer, a write pointer and a recovery pointer of the ring buffer, controls the ring buffer and also stores pointer information of the ring buffer as a prescribed unit data list when there is a condition which does not make it possible to transfer the prescribed unit data to the memory means as a result that the prescribed unit data in the ring buffer has been checked on the identification list.

The data acquisition means for acquiring the prescribed unit data is, for example, a packet separation processing unit which separates packets of the prescribed unit data. The memory means is, for example, a file cache. The first processing unit consists of an application storage unit which stores a plurality of applications therein; and an application processing unit which includes a list storage unit of necessary resource data which stores a plurality of items of resource data to be processed by the plurality of applications, respectively, so as to be applicable to a variety of kinds of resource data to be stored in the file cache. The second processing unit is a resource data load processing unit which includes a ring buffer control unit which has the read pointer, the write pointer and the recovery pointer of the ring buffer, and controls the ring buffer; and a packet list storage unit which stores the pointer on the ring buffer as a packet list of the resource data when there is the condition which does not make it possible for the resource data to be transferred to the file cache in storing the packets which have been separated by the packet separation processing unit in the ring buffer.

That is, the ring buffer which temporarily stores the packets of the resource data in a stream is used. The packet which has been read out from the ring buffer is basically transferred to the file cache in response to the playlist. Here, if the storage area of the file cache cannot be secured, the packet list of the packets to be stored in the ring buffer is stored in a pack list memory. This packet list includes the pointer on the ring buffer of the packets composing the resource data.

The foregoing means makes it possible to transfer the packets of the resource data at a high speed from the ring buffer to the file cache by utilizing the packet list when a free space has been made in a storage capacity of the file cache. If the capacity of the file cache is small, the memory may be effectively utilized.

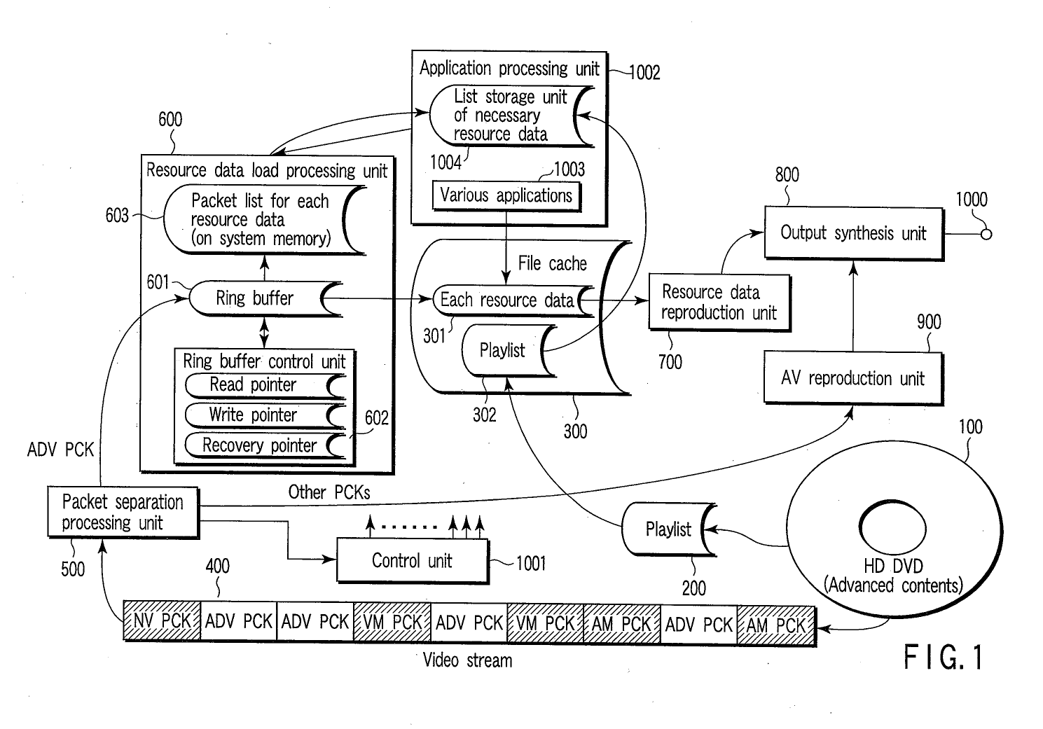

Hereinafter, embodiments of the invention will be described concretely with reference to the drawings. FIG. 1 depicts a configuration view of an HD DVD player with the invention applied thereto, and specifically depicts the player by extracting a part related to the invention.

Data of an HD DVD 100 is read out through an optical head device, error-corrected, and then, read out by means of a data access manager (not shown). A playlist 200 in management information is stored in a file cache 300. A video stream 400 is input to a packet separation processing unit 500.

An advanced packet (ADV PCK) which has been separated by the processing unit 500 is stored in a ring buffer 601 of a resource data load processing unit 600.

The processing unit 600 includes a ring buffer control unit 602. A system memory has a packet list storage unit 603 thereon. The control unit 602 has the read pointer, the write pointer and the recovery pointer of the ring buffer 601 and controls these pointers.

A resource data storage unit 301 of the file cache 300 stores data which has been read out from the ring buffer 601. The file cache 300 includes the storage unit 301 and a playlist storage unit 302. The storage unit 301 stores and outputs each item of resource data in accordance with the playlist.

The resource data which has been output from the file cache 300 is input to a resource data reproduction unit 700 to be decoded. The resource data which has been decoded is input to an output synthesis unit 800. The synthesis unit 800 performs synthesis processing between the decoded resource data and decoded AV data from an AV reproduction unit 900, and outputs the synthetic signal to a display connecting terminal 1000. The reproduction unit 900 is a part which decodes the AV data such as a main video pack (VM PCK), a sub video pack (VS PCK), a main audio pack (AM PCK), a sub audio pack (AS PCK) and a sub picture pack (SP PCK) which has been separated by the packet separation processing unit 500. A navigation pack (NV PCK) is taken into a control unit 1001 and utilized as information which acquires a variety of control signals.

The device further includes an application processing unit 1002. The processing unit 1002 includes an application storage unit 1003 with a variety of kinds of applications stored therein. The variety of kinds of applications in the storage unit 1003 are utilized for deciding a processing procedure of the data in the file cache 300.

The processing unit 1002 further includes a list storage unit 1004 of necessary resource data. The storage unit 1004 of the necessary resource data is a part which responds for an inquiry from the resource data load processing unit 600.

When the ADV PCK is separated from the packet separation processing unit 500, the ADV PCK is stored in the ring buffer 601 of the processing unit 600. The ring buffer 601 performs processing to move the write pointer by one packet for the next writing. In reading a packet, if the packet is a start packet, the processing unit 600 inquires of the application processing unit 1002 as to whether or not the data of the ADV PCK is needed.

The processing unit 1002 which has been questioned determines whether or not the data of the ADV PCK is the data corresponding to the resource data which has been processed in the file cache, and whether or not there is the free space in file cache on the basis of current playlist information. It may be determined whether or not (1) the data of the ADV PCK is the data corresponding to the resource data now in the processing on the basis of attribute data (identifier (advanced-identifier)) of the ADV PCK. It may be determined whether or not (2) the file cache 300 has a free space on the basis of management information which has been managed by the file cache manager (not shown). The cache manager manages writing addresses, reading addresses, etc., of the file cache 600. The application processing unit 1002 responds, as the determination result, as to whether the free space exists or not and whether the ADV PCK is the necessary resource data (namely, whether or not the data is continued data corresponding to the resource data which has been processed currently).

As the determination result, if the data of the ADV PCK is the continued data (R1 next) related to the resource data (R1) which has been processed in the file cache 600, the data of the ADV PCK firstly becomes data to be transferred to the file cache 300. Next, the application processing unit 1002 writes the stored ADV PCK in the file cache 600 on the basis of the read pointer of the ring buffer 601. The ring buffer 601 increments the read pointer in order to perform the next reading. After starting the storing of the AV PCK in the file cache 300 in the given manner (if a required pack has been obtained), the processing unit 1002 always stores the resource data in the cache 300 from the ring buffer. At the time when the first pack has been obtained, the file cache 300 has already secured the area to store the resource data. The ring buffer 601 increments the read pointer for the next reading continuously.

As the foregoing determination result, if the data of the ADV PCK is the resource data (R2) having no relation with the resource data (R1) being in the processing in the file cache 600, the resource data processing unit 600 writes the ADV PCK in the ring buffer 601 on the basis of the recovery pointer. The processing unit 600 describes the address of the corresponding ADV PCK in the packet list storage unit 603 on the system memory.

The present invention is characterized in that the ring buffer 601 is characteristically controlled in the resource data load processing unit 600.

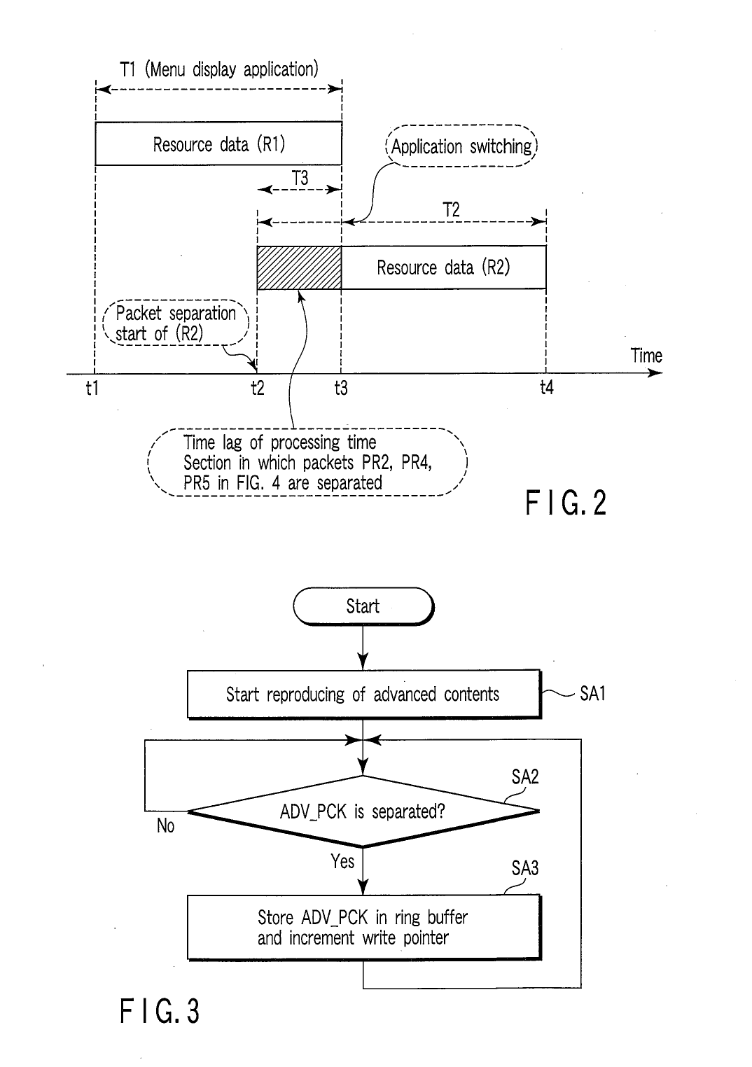

FIG. 2 illustrates a simplistic aspect in which the resource data (R2) is recovered by means of the operations of the aforementioned device. Now, it is assumed that, for example, the resource data (R1) for a menu is processed in a section T1 of time points t1-t3 on a time axis, based on the menu display application. It is assumed that the resource data (R2) for video commentary is processed in a section T2 of time points t3-t4, based on the video commentary application. However, it is assumed that the packet separation processing of the resource data (R2) is started at a time point t2, and a section T3 is overlapped in the processing period of the resource data (R1).

In such case, in the section T1, the file cache 300 processes the resource data (R1). Therefore, even when the packet of the resource data (R2) has been separated, the application processing unit 1002 responds to the resource data processing unit 600 to that the resource data (R2) is unclear resource data.

At this moment, the processing unit 600 always and firstly stores the packets of the resource data (R2) in the ring buffer 601 regardless of the necessity and/or the unclearness. It is assumed that the time point is now at t3, the processing of the resource data (R2) is completed, and the file cache 300 is enabled to process the resource data (R2). The ADV PCK of the resource data (R2) stored in the ring buffer 601 in the section T3 is then transferred in one burst to the file cache 300 from the ring buffer 601, based on the packet list of the packet list storage unit 603. After this, the processing unit 600 executes the reproduction of the resource data (R2) on the basis of the video commentary application. The packet list is then cleared.

FIG. 3 depicts an operation flow of the packet separation processing unit 500. When the reproduction of the advanced contents is started (Step SA1), the processing unit 500 determines whether or not the ADV PCK is separated (Step SA2). If the ADV PCK has been separated, the Adv PCK is stored in the ring buffer 601. The ring buffer control unit 602 increments the write pointer.

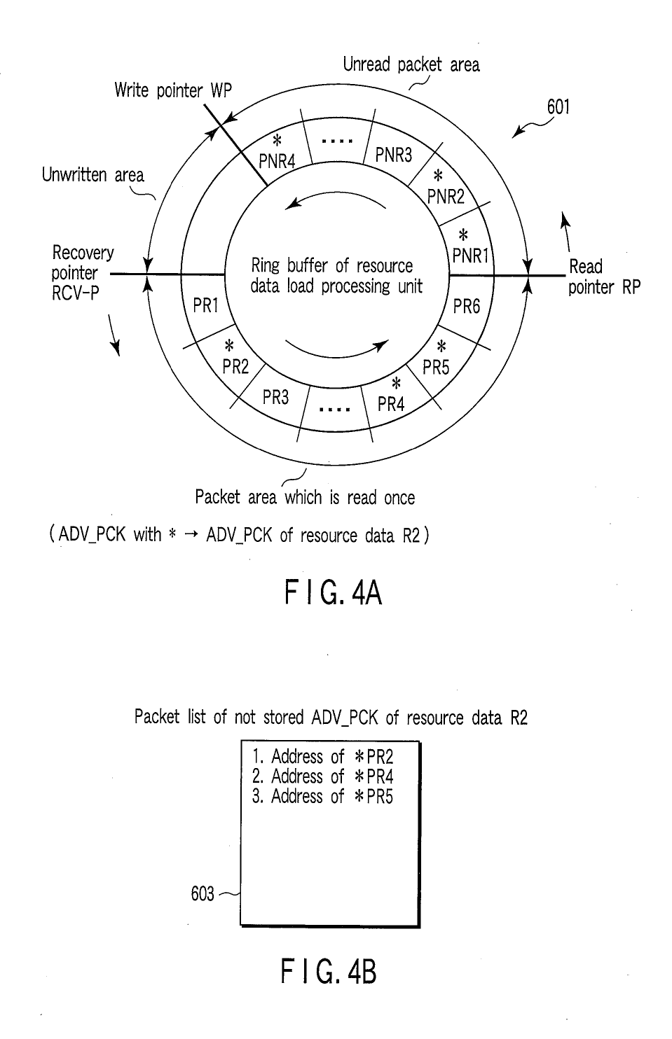

FIG. 4A schematically illustrates the storage area of the ring buffer 601, and FIG. 4B illustrates an example of a data storage state of the packet list storage unit 603. In the section T3, an aspect in which packets (to which mark * are added)*PR2, *PR4 and *PR5 of the packets of the resource data (R2) as the ADV PCKs are stored in the packet area (area from recovery pointer RCV-P to read pointer RP) which has been read out once. In response to this, the addresses of each of the packets *PR2, *PR4 and *PR5 and the identifier of the resource data 2R are stored in the storage unit 603. For example, for reading out the packets from the ring buffer 601, it is enabled to check the corresponding resource data by using this identifier. While FIG. 4A illustrates the packets *PNR1, *PNR2 and *PNR4, these packets have not been read out yet, FIG. 4A illustrates an aspect of the packets to be stored in the ring buffer 601 later (time point t3 or later, refer to FIG. 2).

At the time point t3 or later, the ring buffer 601 starts to transfer the data to the file cache 300. At this moment, the packet list is referred to, and the packets *PR2, *PR4 and *PR5 are sequentially transferred to the file cache 300. At this time, the application processing unit 1002 checks between the list of the necessary resource data and the packet list of each resource data, and loads the packets of the matched resource data from the ring buffer 601 to the file cache 300. In other words, the processing unit 1002 checks between the advanced identifiers of the packets and the advanced identifiers of the resource data listed on the necessary resource data list, and if the checking results in matching, the processing unit 1002 permits the transfer of the packets.

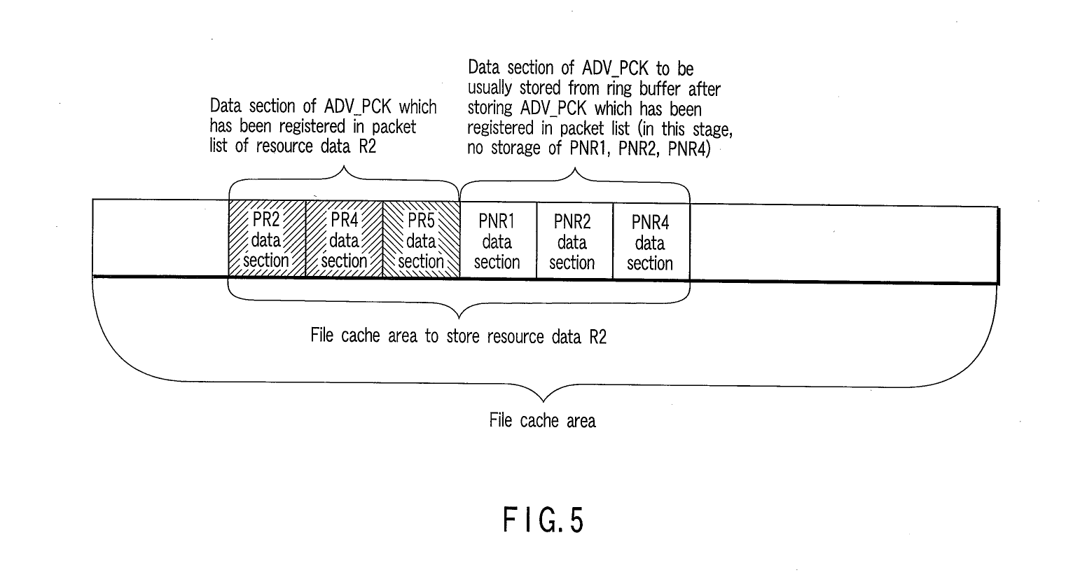

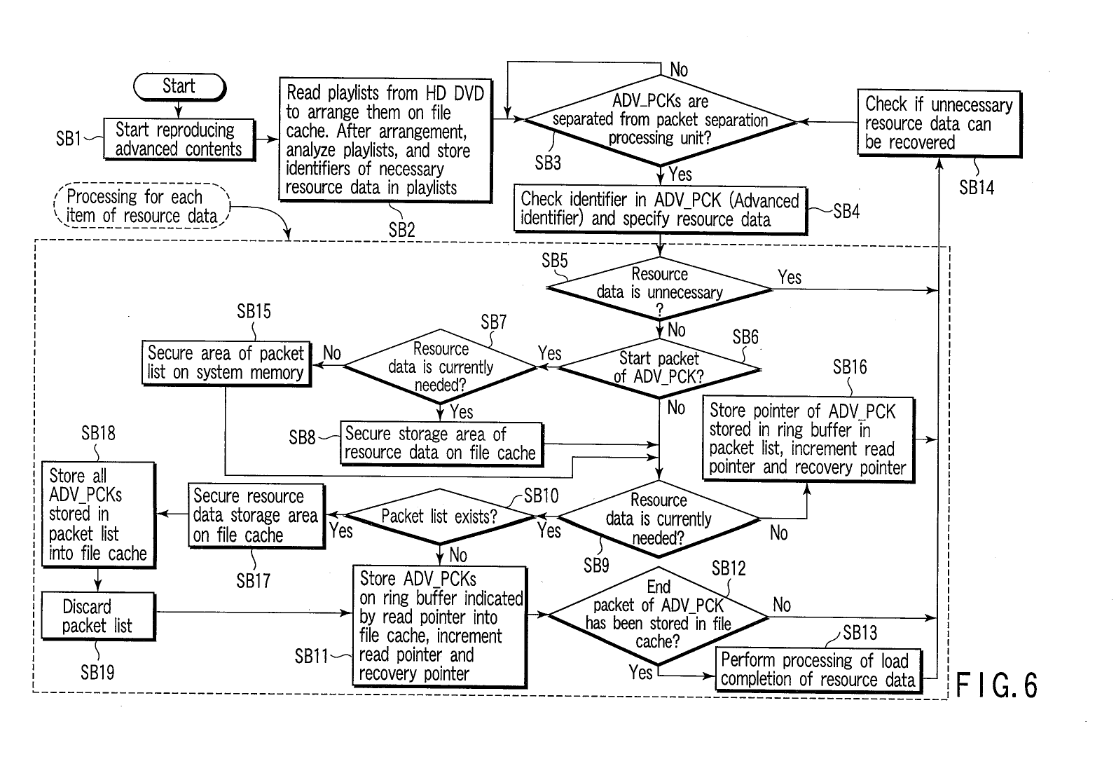

FIG. 5 shows an example of the storage area in the file cache, and shows an aspect just after the packets *PR2, *PR4 and *PR5 has been transferred. At this moment, the packet list in the packet list storage unit 603 is cleared.

The ADV PCK of the resource data (R2) that has been separated after such transfer is stored in the ring buffer 601 on the basis of the write pointer WP. The packets to be transferred to the file cache 601 are read out from the ring buffer 601, based on the read pointer RP.

The packets *PNR1, *PNR2 and *PNR4 in FIG. 4A and FIG. 5 illustrate aspects in which the packets which have been separated at the time point t3 or later (refer to FIG. 2) are stored.

As given above, by utilizing the ring buffer 601, the ring buffer control unit 602 (recovery pointer RCV-P) and the packet list storage unit 603, the reproducing device may respond to the processing of the ADV PCKs performed by various providers without enlarging the capacity of the file cache memory 300. The device makes it possible to reproduce as many kinds of resource data as possible without discarding the resource data.

Since the packet lists of the resource data have been prepared, the processing of reading out the resource data from the ring buffer 601 is performed at a high speed. In the given embodiment, the packet list storage unit 603 stores the packet list of the resource data (R2). However, the packets of the other items of resource data (R3), (R4), . . . , are reproduced sometimes. In such case, the packet list storage unit 603 may prepare packet lists for each resource data.

FIG. 6 illustrates the entire operations of the inventive device. More specifically, this device resolves the time lag between the processing time of the application processing 1002 and that of the packet separation processing unit 500.

It is presently assumed that there is a menu display application using the resource data (R1) (64 MB) with the voice file stored therein and a video commentary application using the resource data (R2) (20 MB) with a plurality of NPG files stored therein. It is also assumed that there is a file cache (64 MB) which stores the resource data. The ring buffer 601 which stores the ADV PCK separated from the video stream is prepared (read pointer, write pointer and recovery pointer are used for controlling).

When starting the reproduction of the advanced contents (Step SB1), the device loads an HD DVD playlist in the file cache 300. The file cache manager analyzes the playlist to store the resource data (identifiers of resource data (R1), resource data (R2) (Advanced identifiers (1, 2)) required from the applications 1 and 2 in a list 1004 of the list storage unit 1004 of necessary resource data (Step SB2).

In reproducing the advanced contents, when the ADV PCK for the resource data 1 is separated through the packet separation processing unit 500 (Steps SB3, SB4), the device writes it in the ring buffer 601, and increments the read pointer RP and the write pointer WP of the ring buffer 601 according to the size of the packet.

When the ADV PCKs are stored in the ring buffer 601, the device reads them and performs storage processing in the file cache sequentially. The read pointer RP and the recovery pointer RCV-P of the ring buffer 601 are incremented by the size×the number of the ADV PCKs which have been read from the ring buffer 601.

In the reading processing, if the ADV PCK is the start packet of the resource data R1, the resource data load processing unit 600 transfers the identifier of the ADV PCK to the application processing unit 1001 to inquire if the resource data R1 is needed. As the inquiry result, if the resource data R1 is required, the processing unit 600 secures the area to store the resource data R1 in the file cache 300 and stores it in the file cache 300 (Steps SB4, Sb5, SB6, SB7, SB8, SB9, SB10 and SB11). In the reading processing, if the ADV PCK is an end packet of the resource data R1 (Step SB12), after storing in the file cache, the processing unit 600 performs load completion processing of the resource data 1 (processing in a route of Steps SB10, SB11, SB12, SB13, SB14 and SB3).

After completing the load of the resource data R1, the menu display application starts the processing of the resource data R1.

When the menu display application completes the processing of the resource data R1, the video commentary application starts the processing of the resource data R2 (start from time point 2 in FIG. 2).

During the processing of the resource data R1 by the menu display application, the ADV PCK of the resource data R2 is separated from the video stream through the packet separation processing unit 500. The separated ADV PCK is stored in the ring buffer 601. The write pointer WP of the ring buffer 601 is then incremented by the size of the ADV PCK.

In reading processing, if the ADV PCK is the start packet of the resource data R2, the advanced identifier of the ADV PCK is transferred to the application processing unit 1002 to inquire if the resource data R2 is needed. As the inquiry result, since the area in which the ADV PCK of the resource data R2 to be stored cannot be secured on the file cache 300, a response indicating the fact that the ADV PCK is needed but disabled to be stored or the possibility of being stored is not clear is sent.

In this case, until a request of the resource data R2 is made from the application processing unit 1002, the device prepares the packet list from the resource data R2 to store the pointers on the ring buffer of the ADV PCK of the resource data R2 in the packet list (processing route of Steps SB7, SB15, SB9, and SB16).

After the completion of the processing of the resource data R1 through the menu display application, the application processing unit 1002 releases the area of the resource data R1.

Releasing the resource data R1 makes it possible for the file cache 300 to secure the area in which the ADV PCKs of the resource data R2 are stored. At this moment, the application processing unit 1002 requires the resource data R2 (advanced identifier (2)) to be sent to the resource data load processing unit 600.

At this time, the application processing unit 1002 or the file cache manager secures the area to store the ADV PCKs of the resource data R2 on the file cache 300, and stores the ADV PCKs (exist in packet area which has been read once) stored in the packet list in the file cache 300. After storing, the packet list is discarded (processing route in Steps SB10, Sb17, SB18, SB19 and SB11). Using the packet list makes it possible to read in the ADV PCKs of the resource data R2, directly, at a high speed without having to retrieve the entire of the packet area which has been read once.

After completing the storage of the ADV PCKs stored in the packet list, the device stores the ADV PCks which have separated from the video stream through the packet separation processing unit in an ordinary manner.

After completing the load of the resource data R2, the video commentary application starts the processing of the resource data R2.

In the ring buffer 601 (FIG. 4A), an unread packet area+unwritten area (area of read pointer write pointer−recovery pointer) is set to a size capable of corresponding to a bit rate of the video stream. A packet area (area of recovery pointer−read pointer) which has been read once is set to a size capable of absorbing a time lag in processing time. Only a packet in the packet area that has been read once may be read again.

If the recovery pointer has passed though the packet which has been read once, the packet which has been read once may not be used. This is because the ADV PCK which has newly separated by the packet separation processing unit is overwritten on the foregoing packet. Thus, in the case in which the recovery pointer has passed though the start packet of the resource data which is not needed currently, the load of the resource data is cancelled.

Step SB14 in FIG. 6 checks whether or not the recovery pointer has passed through the start packet (e.g., *PR2 of FIG. 2) of the resource data which is not needed at present. That is, Step SB14 checks whether the resource data can be recovered or not. At this time, a part of the resource data R2 does not exist, and it is useless to reproduce such resource data. Therefore, in this case, the load of the resource data is cancelled. The packet lists in this case are discarded.

In the application processing unit 1002, the resource data list storage unit 1004 mainly checks the identifiers included in the list of the necessary resource data and the identifiers included in the packet list of each item of resource data with one another, and if the identifiers of both the lists are matched to one another, the processing unit 1002 allows loading the packets of the resource data from the ring buffer to the file cache.

In the resource data road processing unit 600, when completing the loading from the ring buffer to the file cache, the packet list storage unit 603 discards the packet lists. Moreover, in the processing unit 600, when the recovery pointer has passed through a storage position of resource data which is not currently needed in the file cache, the resource data load processing unit (the ring buffer control unit 602) cancels loading the resource data. In this case the ring buffer control unit 602 also discards the packet lists of such resource data.

While the present invention has been described as being applied to a DVD reproduction device, the invention is not limited to such case, and it applies to any type of reproducing device that utilizes a memory means using the ring buffer.

It is our intention that the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from all the constituent elements shown in the embodiments mentioned above. Further, the constituent elements over different embodiments may be appropriately combined.

While certain embodiments of the inventions have been described, these embodiments have been presented by way of example only, and are not intended to limit the scope of the inventions. Indeed, the novel methods and systems described herein may be embodied in a variety of different forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproducing device of an information storage medium, comprising:
data acquisition means for acquiring prescribed unit data;
a ring buffer which temporarily stores the prescribed unit data from the data acquisition means;
memory means for storing the prescribed unit data from the ring buffer in response to an application;
a first processing unit which stores the application for processing the prescribed unit data to be stored in the memory means and stores an identification list which indicates presence or absence of a relation between the application and the prescribed unit data; and
a second processing unit which includes a read pointer, a write pointer, and a recovery pointer of the ring buffer and controls the ring buffer, and also stores pointer information of the prescribed unit data in the ring buffer as a prescribed unit data list when there is a condition which does not make it possible to transfer the prescribed unit data to the memory means as a result that the prescribed unit data in the ring buffer has been checked with the identification list.

2. The device according to claim 1, wherein when a transfer request of the prescribed unit data remaining in the ring buffer is made from the first processing unit, the second processing unit transfers the prescribed unit data remaining in the ring buffer to the memory means on the basis of the pre scribed unit data list.

3. The device according to claim 2, wherein the first processing unit outputs the transfer request on the basis of the application.

4. The device according to claim 1, wherein
the prescribed unit data is a packet;
the data acquisition means is a packet separation processing unit which separates the packets;
the memory means is a file cache;
the first processing unit is an application processing unit which includes an application storage unit with a plurality of applications to process a variety of kinds of resource data to be stored in the file cache stored therein; and a necessary resource data list storage unit which stores a list of a plurality of items of resource data to be processed by the plurality of applications, respectively; and
the second processing unit is a resource data load processing unit which includes a ring buffer control unit including a read pointer, a write pointer and a recovery pointer of the ring buffer to control the ring buffer; and a packet list storage unit storing a packet list of resource data of the ring buffer when there is a condition which does not make it possible to transfer the resource data to the file cache.

5. The device according to claim 4, wherein the packet list to be stored in the packet list storage unit is packets of the necessary resource data which have been stored in the necessary resource data list storage unit.

6. The device according to claim 5, wherein the packet list is added with an identifier which makes it possible to check with the resource data.

7. The device according to claim 4, wherein the application processing unit checks identifiers included in a list of necessary resource data with identifiers included in a packet list of each kind of resource data, and allows loading packets of resource data of which the identifiers are matched from the ring buffer to the file cache.

8. The device according to claim 4, wherein the resource data load processing unit discards the packet lists after completing loading from the ring buffer to the file cache.

9. The device according to claim 4, wherein when the recovery pointer has passed through a storage position of a start packet of resource data which is not currently needed in the file cache, the resource data load processing unit cancels loading the resource data.

10. The device according to claim 4, wherein when the recovery pointer has passed through a storage position of a start packet of resource data which is not currently needed in the file cache, the resource data load processing unit discards packet lists of the resource data.

11. A reproducing method of an information storage medium, comprising
a packet separation processing unit which outputs separated packets;
a file cache;
an application processing unit which includes an application storage unit and a necessary resource data list storage unit, wherein the application storage unit stores a plurality of applications to process resource data of packets to be stored in the file cache, and the necessary resource data list storage unit stores a plurality of lists of resource data to be processed by the plurality of applications, respectively; and
a resource data load processing unit which includes a ring buffer to store the separated packets and a ring buffer control unit, wherein when there is a condition which does not make it possible to transfer the resource data of the packets in the ring buffer on the basis of the plurality of lists of resource data,
the application processing unit and the resource data load processing unit store packet lists of the resource data, and when it becomes able to transfer the resource data to the file cache,
the application processing unit and the resource data load processing unit read out packets in the ring buffer in accordance with the packet lists.

12. The method according to claim 11, wherein when completing loading from the ring buffer to the file cache, the resource data load processing unit discards the packet lists.

13. The method according to claim 11, wherein when the recovery pointer has passed through a storage position of resource data which is not currently needed in the file cache, the resource data load processing unit cancels loading the resource data.

14. The method according to claim 11, wherein when the recovery pointer has passed though a storage position of a start packet of resource data which is not currently needed in the file cache, the resource data load processing unit discards the packet lists of the resource data.
